(19) United States
(12) Patent Application Publication
(10) Pub. No.: US 2026/0323630 A1
(43) Pub. Date: Oct. 15, 2026

(54) Coverage Enhancement for PUSCH

(71) Applicant: Apple Inc., CUPERTINO, CA (US)

(72) Inventors: Chunhai YAO, Beijing (CN); Ankit BHAMRI, Haar (DE); Chunxuan YE, San Diego, CA (US); Dawei ZHANG, Saratoga, CA (US); Hong HE, San Jose, CA (US); Seyed Ali Akbar FAKOORIAN, San Diego, CA (US); Wei ZENG, Saratoga, CA (US)

(21) Appl. No.: 18/870,498

(22) PCT Filed: Dec. 1, 2023
(86) PCT No.: PCT/CN2023/135973

§ 371 Date: Nov. 29, 2024

(51) Int. Cl. H04W 72/1268; H04W 72/232; H04W 72/542

(52) U.S. Cl. CPC H04W 72/1268; H04W 72/232; H04W 72/542

(57) ABSTRACT

A user equipment (UE) configured to decode, based on signals received from a base station, first configuration information, determine, based on the first configuration information, that Physical Uplink Shared Channel (PUSCH) repetition is to be enabled for a PUSCH scheduled by fallback Downlink Control (DCI) and configure transceiver circuitry to transmit, to the base station, a request to enable PUSCH repetition for the PUSCH scheduled by fallback DCI

### TECHNICAL FIELD

The present disclosure generally relates to wireless communication, and in particular, to coverage enhancement for PUSCH.

### BACKGROUND

User equipment (UE) may transmit signals to a base station on various channels such as a Physical Uplink Shared Channel (PUSCH), a Physical Uplink Control Channel (PUCCH), etc. The quality of these channels may vary due to any number of factors, e.g., distance between UE and base station, obstructions between UE and base station, channel interference, etc.

Transmitting signals with repetition may be one manner of handling channels that may have a lower quality. However, while transmitting with repetition may increase a likelihood that the signals are received by the base station, the use of repetitions may decrease the throughput on the channel. Therefore, repetition may not be desired in all circumstances.

### SUMMARY

Some example embodiments are related to an apparatus of a user equipment (UE), the apparatus including processing circuitry configured to decode, based on signals received from a base station, first configuration information, determine, based on the first configuration information, that Physical Uplink Shared Channel (PUSCH) repetition is to be enabled for a PUSCH scheduled by fallback Downlink Control (DCI) and configure transceiver circuitry to transmit, to the base station, a request to enable PUSCH repetition for the PUSCH scheduled by fallback DCI

Other example embodiments are related to an apparatus of a base station, the apparatus including processing circuitry configured to configure transceiver circuitry to transmit first configuration information to a user equipment, wherein the first configuration information comprises an indication of when Physical Uplink Shared Channel (PUSCH) repetition is to be enabled for a PUSCH scheduled by fallback Downlink Control (DCI) and decode, based on signals received from the UE, a request to enable PUSCH repetition for the PUSCH scheduled by fallback DCI.

### BRIEF DESCRIPTION OF THE DRAWINGS

FIG. 1 shows an example network arrangement according to various example embodiments.

FIG. 2 shows an example UE according to various example embodiments.

FIG. 3 shows an example base station according to various example embodiments.

FIG. 4 shows an example signaling diagram for a random access channel (RACH) procedure to transition a UE from a Radio Resource Control (RRC) Idle state to a RRC Connected state according to various example embodiments.

FIG. 5 shows an example method for configuring and transmitting Physical Uplink Shared Channel (PUSCH) repetitions scheduled by fallback Downlink Control Information (DCI) according to various example embodiments.

### DETAILED DESCRIPTION

The example embodiments may be further understood with reference to the following description and the related appended drawings, wherein like elements are provided with the same reference numerals. The example embodiments relate to configuring a UE with repetition for a PUSCH, the PUSCH to be scheduled by fallback Downlink Control Information (DCI).

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, the example embodiments may also be implemented in other types of networks, including but not limited to legacy cellular networks (e. g., Long Term Evolution (LTE) ), future evolutions of the cellular protocol (e.g., 5G advanced, 6G, etc.), or any other type of network.

The example embodiments are described with reference to fallback Downlink Control Information (DCI). For example, during an RRC reconfiguration procedure, the network may not be aware of when the UE applies the RRC reconfiguration. Thus, the network (e.g., a base station) may send fallback DCI during this time when it is uncertain as to the progress of the UE in applying the RRC reconfiguration parameters. This fallback DCI may schedule Physical Uplink Shared Channel (PUSCH) for the UE. An example of a fallback DCI is DCI Format 0_0. However, the example embodiments may be applied to any type of fallback DCI.

As described above, the use of repetition may increase the likelihood that a signal transmitted by the UE reaches the base station. Thus, use of repetitions may be considered a coverage enhancement for the UE because the signals are more likely to reach the base station. Currently there are no manners of configuring a UE to use repetitions when the UE is scheduled for PUSCH by fallback DCI or for Msg5 PUSCH transmissions. Throughout this description when it is described that repetitions are used when the UE is scheduled for PUSCH by fallback DCI, this may also apply to Msg5 PUSCH transmissions.

The example embodiments provide manners of configuring a UE to perform PUSCH repetitions for PUSCH scheduled by fallback DCI and for the UE to enable PUSCH repetitions for PUSCH scheduled by fallback DCI. The configuration includes parameters that the UE may use to determine whether PUSCH repetitions should be enabled, manners of transmitting a request to the network to enable PUSCH repetitions and parameters to perform the transmission of PUSCH repetitions to the network. These and other example embodiments are described in greater detail below.

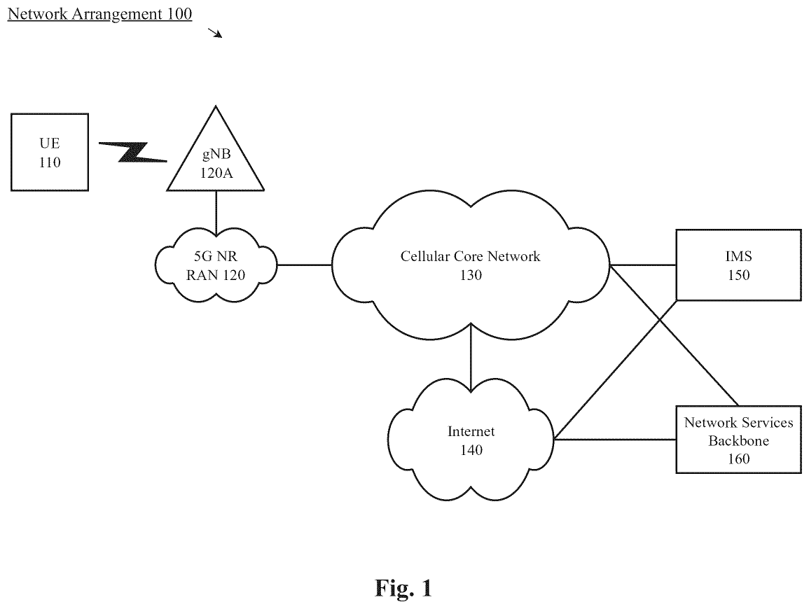

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IOT) devices (including connected vehicles), etc. An actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. The UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120.

Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A.

However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

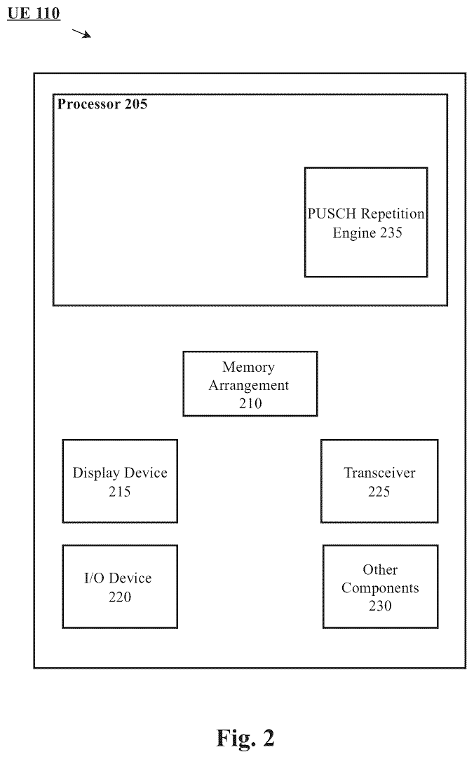

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, one or more antenna panels, etc.

The processor 205 may be configured to execute a plurality of engines for the UE 110. For example, the engines may include a PUSCH repetition engine 235 for performing operations related to the UE 110 transmitting repetitions for PUSCH scheduled by fallback DCI. The operations may include, but are not limited to, receiving configuration parameters for enabling PUSCH repetitions, transmitting a request to the network to enable PUSCH repetitions, receiving configuration parameters for transmitting the PUSCH repetitions and transmitting the PUSCH repetitions to the network. These and other example operations are described in further detail below.

The above referenced engine being an application (e. g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

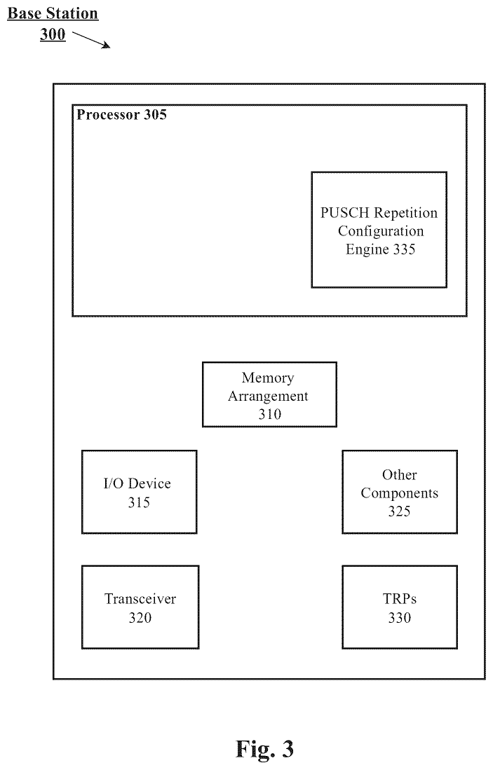

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, other components 325, and one or more transmission and reception points (TRPs) 330. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a PUSCH repetition configuration engine 335 for performing operations related to configuring a UE to perform PUSCH repetitions for PUSCH scheduled by fallback DCI. The operations may include, but are not limited to, configuring the UE with parameters for enabling the PUSCH repetitions, receiving a request from the UE to enable PUSCH repetitions and configuring the UE with parameters to perform the transmission of PUSCH repetitions. These and other example operations are described in further detail below.

The above referenced engine being an application (e. g., a program) executed by the processor 305 is only example. The functionality associated with the engines may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. The engines may also be embodied as one application or separate applications. In addition, in some base stations, the functionality described for the processor 305 is split among two or more processors such as a baseband processor and an applications processor. The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e. g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

The example embodiments are related to configuring the UE 110 for repetition for PUSCH scheduled by fallback DCI. Initially, a random access channel (RACH) procedure that is performed between the UE 110 the base station 300 is described. This RACH procedure is described because it illustrates a scenario where the UE 110 may be configured with PUSCH scheduled by fallback DCI, e.g., a scenario where the example PUSCH repetitions may be configured.

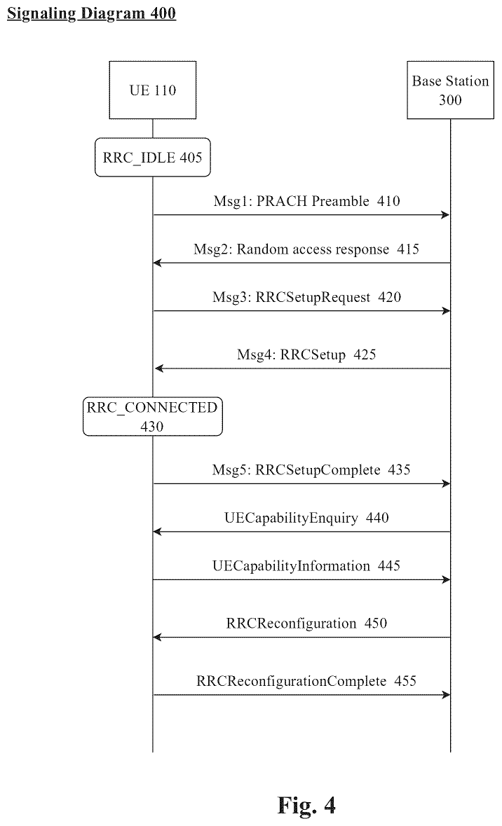

FIG. 4 shows an example signaling diagram 400 for a RACH procedure to transition a UE from a Radio Resource Control (RRC) Idle state to a RRC Connected state according to various example embodiments. The RACH procedure of the signaling diagram 400 is performed between the UE 110 and the base station 300, e. g., gNB 120A. The UE 110 is initially in the RRC Idle state 405.

In 410, the UE 110 initiates the RACH procedure by sending a Msg1 comprising a Physical RACH (PRACH) preamble to the base station 300. In 415, the base station 300 responds to the Msg1 with a Msg2 that is a random access response. In 420, the UE 110 responds with a Msg3 comprising a RRC Setup Request. In 425, the base station 300 responds with a Msg4 RRC Setup message. After receiving the Msg4, the UE 110 may transition from the RRC Idle state 405 to the RRC Connected state 430.

In 435, the UE 110 sends a Msg5 comprising a RRC Setup Complete message to the base station 300 to indicate the UE 110 has completed the RRC setup. In 440, the base station 300 may send a UE Capability Enquiry requesting the capabilities of the UE 110. In 445, the UE 110 may respond with a UE Capability Information response to indicate the UE capabilities to the base station 300. In 450, the base station 300 may send an RRC Reconfiguration message to the UE 110. In 455, the UE 110 may respond with an RRC Reconfiguration Complete message to the base station 300.

The RACH procedure 400 of FIG. 4 is only an example and the example embodiments are not limited to this type of RACH procedure. There may be various issues related to configuring a UE with PUSCH repetitions when the PUSCH is scheduled by fallback DCI. These issues include, but are not limited to, how to enable the repetitions for PUSCH scheduled by fallback DCI, how to configure the repetition request for PUSCH scheduled by fallback DCI, how to indicate a repetition factor for PUSCH scheduled by fallback DCI and how to perform frequency hopping for PUSCH scheduled by fallback DCI. The example embodiments address these and other issues.

FIG. 4 also shows that the fallback DCI may schedule PUSCH at various times during the RACH procedure. For example, in one scenario there may be PUSCH scheduled by fallback DCI that occurs after Msg3 (e.g., operation 420) and before the RRC reconfiguration complete (e.g., operation 455). Such PUSCH may include the Msg5 (e. g., operation 435). In another scenario, there may be PUSCH scheduled by fallback DCI that occurs after RRC reconfiguration (e.g., operation 455). This type of PUSCH may be scrambled by a Cell Radio Network Temporary Identifier (C-RNTI) or a Modulation and Coding Scheme C-RNTI (MCS-C-RNTI). The configuration for the PUSCH repetitions for these different scenarios may be treated differently. Some examples will be provided below.

The following provides examples of when PUSCH repetitions may be enabled by the UE 110. These examples may be applied to any of the scenarios described above, e.g., PUSCH before the RRC reconfiguration and/or PUSCH after the RRC reconfiguration. In some example embodiments, the UE 110 may be provided with a dedicated Synchronization Signal Block (SSB) Reference Signal Received Power (RSRP) threshold associated with PUSCH scheduled by fallback DCI. For example, the UE 110 may measure the SSBs transmitted by the base station 300. The UE 110 may enable PUSCH repetitions for PUSCH scheduled by fallback DCI when the SSB RSRP is below the SSB RSRP threshold. The SSB RSRP threshold may be signaled to the UE 110 via a System Information Block (SIB) transmitted by the base station 300, e.g., SIB1.

In other example embodiments, the UE 110 may use the the same PRACH repetition RSRP threshold to enable the PUSCH repetition for PUSCH scheduled by fallback DCI. For example, the UE 110 may be configured with an SSB RSRP threshold to enable repetitions for PRACH (e.g., operation 405). The UE 110 may apply this same SSB RSRP threshold to enable the PUSCH repetition for PUSCH scheduled by fallback DCI.

In further example embodiments, the UE 110 may use the same Msg3 PUSCH RSRP threshold to enable the PUSCH repetition for PUSCH scheduled by fallback DCI. For example, the UE 110 may be configured with an SSB RSRP threshold to enable repetitions for Msg3 (e.g., operation 420). The UE 110 may apply this same SSB RSRP threshold to enable the PUSCH repetition for PUSCH scheduled by fallback DCI.

In additional example embodiments, the SSB RSRP threshold may be set to a specific value that the UE 110 may can treat as an infinite RSRP threshold, which indicates that PUSCH repetition for PUSCH scheduled by fallback DCI is enabled. For example, the SSB RSRP may be communicated to the UE 110 in an information element (IE) in the form of a specific value (e.g., dBm). However, the IE may also include a bit value corresponding to infinity that indicates that repetition for PUSCH scheduled by fallback DCI is always enabled, e.g., any RSRP value enables PUSCH repetition.

The UE 110 may report its capability with respect to the repetitions for PUSCH scheduled by fallback DCI and request that the PUSCH repetition be enabled (e.g., based on the RSRP examples provided above). In some example embodiments, a PRACH resource may be used to differentiate the repetition of PUSCH scheduled by fallback DCI from a single transmission (e.g., during operation 410). For example, a separate preamble with shared RACH Occasion (RO) may be configured by the same PRACH configuration index for legacy UEs, e.g., a first preamble corresponding to the single transmission and a second preamble corresponding to the PUSCH repetitions may be sent in the same RO. In another example, a separate RO may be configured from a PRACH configuration index for legacy UEs, e.g., the PRACH comprising the PUSCH repetition is sent in a different PO from the single transmission RO.

In other example embodiments, the UE 110 may send the PUSCH repetition request using the Msg3 PUSCH higher layer signaling (e.g., during operation 420). In one example, there are reserved Logical Channel Identification (LCID) codepoints in the Table 6.2.1-2 of the 3GPP Technical Specification (TS) 38.321. One or more of these codepoints may be used to signal the PUSCH repetition request during the Msg3 PUSCH higher layer signaling. In another example, there are reserved (‘R’) bits in the Medium Access Control (MAC) sub-header as shown in FIG. 6.1.2-3 of 3GPP TS 38.321. One or more of these ‘R’ bits may be repurposed to signal the PUSCH repetition request during the Msg3 PUSCH higher layer signaling. In a still further example, there are reserved enhanced LCID (eLCID) codepoints in Table 6.2.1-2b of 3GPP TS 38.321. One or more of these codepoints may be used to signal the PUSCH repetition request during the Msg3 PUSCH higher layer signaling.

When the UE 110 requests the network (e.g., the base station 300) to enable the PUSCH repetition for PUSCH scheduled by fallback DCI, the base station 300 may schedule the PUSCH with repetition or without repetition. When the UE 110 does not request repetition of PUSCH scheduled by fallback DCI, the base station 300 may schedule PUSCH without repetition.

When the UE 110 enables PUSCH repetition for PUSCH scheduled by fallback DCI and the base station schedules PUSCH repetition for PUSCH scheduled by fallback DCI, there may be various repetition factors that are used for the PUSCH repetitions, e.g., how many PUSCH repetitions may be transmitted by the UE 110. The UE 110 may be configured with the PUSCH repetition factor via SIB information transmitted by the base station 300, e.g., SIB1. In some example embodiments, there may be candidate set with eight values, e.g., {1, 2, 3, 4, 7, 8, 12, 16}, for PUSCH repetition and the SIB may indicate four values from these eight candidate values. In other example embodiments, four default candidate values may be used, e.g., {1, 2, 3, 4}. There may be other variations of signaled or default repetition factors that may be used with the example embodiments.

In the second scenario described above, e.g., PUSCH after the RRC reconfiguration, when the parameter of repetition factor, e.g., pusch-AggregationFactor, is configured in the RRC Reconfiguration message 450, then PUSCH repetition is enabled. In some example embodiments, a semi-static indication may be used to signal the repetition factor. For example, each repetition factor, e.g., {1, 2, 3, 4, 7, 8, 12, 16}, may be associated with a predetermined SSB RSRP threshold or range and associated with dedicated preambles. The UE 110 may then select the preamble according to a measured RSRP and transmits the PUSCH with the associated repetition factor.

In other example embodiments, a dynamic indication using the uplink (UL) grant DCI may be used by the base station 300 to signal the repetition factor. In one example, the DCI Format 0_0 that is scrambled with the C-RNTI may include an MCS field having 5 bits. In one example, the MCS information field in the UL DCI may be reinterpreted to signal the repetition factor. For example, the two (2) most significant bits (MSB) of the MCS information field may be used to select one repetition factor from a SIB (e.g., SIB1) configured set with 4 candidate values or default values, e.g., the candidate or default repetition factors as described above. The three (3) least significant bits (LSB) of the MCS information field in DCI format 0_0 with cyclic redundancy check (CRC) scrambled by the C-RNTI may be used to indicate one value from eight (8) candidate MCS indexes (e. g., 3 bits=8 values) for PUSCH transmission. The 8 candidate MCS indexes may be configured by SIB (e.g., SIB 1), where MCS 0~7 may be applied if the configuration is absent.

In another example of dynamically indicating the repetition factor, the DCI Format 0_0 that is scrambled with the C-RNTI may include a time domain resource assignment (TDRA) information field having 4 bits. The TDRA information field in the UL DCI may be reinterpreted to signal the repetition factor. For example, 3GPP TS 38.321 includes a Table 6.1.2.1.1-2 for default PUSCH TDRA. This table may be reconfigured to signal the repetition factors. The new TDRA table may be signaled by SIB (e.g., SIB1). In one option, the new TDRA table may include a separate new indication for a slot offset (K2), a mapping type, a Start and Length Indicator (SLIV) and a repetition factor. In another option, the new TDRA table may include a legacy indication for K2, mapping type and SLIV from the legacy TDRA table, and a new indication for repetition factor. If the UE 110 requests the repetition, the new TDRA table may be applied, otherwise the legacy TDRA table may be applied.

In a further example of dynamically indicating the repetition factor, the DCI Format 0_0 that is scrambled with the C-RNTI may include a Hybrid Automatic Repeat Request (HARQ) process number information field having 4 bits. The HARQ process number information field in the UL DCI may be reinterpreted to signal the repetition factor. For example, the two (2) MSB bits of the HARQ process number information field may be used for selecting one repetition factor from a SIB (e.g., SIB1) configured set with 4 candidate values or default values and the two (2) LSB bits of the HARQ process number may be used to indicate one value from 4 HARQ processes.

In further example embodiments, a different semi-static indication may be used to signal the repetition factor for PUSCH after the RRC reconfiguration. In these example embodiments, the repetition factor may be indicated semi-statically via an IE, e.g., pusch-AggregationFactor, defined in a PUSCH-configuration, e.g., pusch-AggregationFactor-r19.

In additional example embodiments, a dynamic indication may be used to signal the repetition factor for PUSCH after the RRC reconfiguration. In these example embodiments, the repetition factor may be indicated dynamically via an information field, e.g., numberOfRepetitions, which may be configured in a PUSCH time domain resource allocation information element.

As described above, another issue related to PUSCH repetition is frequency hopping and how to signal frequency hopping parameters to the UE for PUYSCH repetitions scheduled by fallback DCI. In some example embodiments, the DCI Format 0_0 that is scrambled with the C-RNTI may include a frequency hopping flag information field having 1 bit. The frequency hopping flag information field in the UL DCI may be reinterpreted to signal the frequency hopping for PUSCH repetitions scheduled by fallback DCI, e.g., the frequency hopping flag information field may be set to ‘1’ when frequency hopping is enabled.

In some example embodiments, when frequency hopping is enabled, the UE 110 is configured for inter-slot frequency hopping using a resource block (RB) offset for inter-slot frequency hopping that is the same as the Msg3 RB offset. For example, the Msg3 RB offset as defined in 3GPP TS 38.213 Table 8.3-1. In other example embodiments, the inter-slot frequency hopping pattern may be configured via SIB (e.g., SIB1) having an RB offset that is the same as the Msg5 PUSCH frequency hopping RB offset.

In further example embodiments, the inter-slot frequency hopping pattern for PUSCH repetition type A as defined in TS 38.214 Section 6.3.1 may be reused for PUSCH repetition frequency hopping.

In some example embodiments, when PUSCH repetition type A is supported for PUSCH scheduled by fallback DCI is supported, various manners of repetition slot counting may be configured. In one example, a consecutive slot-based counting is configured where every slot is used for counting. This is irrespective of whether the slot is a DL slot, a UL slot or a flexible slot. In another example, the slot counting is based on available slots where the available slots for PUSCH repetition may be determined based on information signaled by the network, e.g., tdd-UL-DL-ConfigurationCommon or ssb-PositionsInBurst IEs. The base station 300 may indicate to the UE 110 that the repetition is based on the consecutive slot or available slot counting via SIB, e.g., SIB1.

The repetition version (RV) identification of the first repetition may be determined based on the RV field having two (2) bits of the DCI Format 0_0 with CRC scrambled by C-RNTI. In some example embodiments, a fixed RV sequence, e. g., [0 2 3 1], for repetition of PUSCH scheduled by fallback DCI may be used. In other example embodiments, RV cycling for PUSCH repetition may be based on transmission occasions.

As described above, the UE 110 may have separate capabilities for supporting PUSCH repetitions for the first and second scenarios, e.g., before the RRC reconfiguration and after the RRC reconfiguration. The UE 110 may report these separate capabilities to the network.

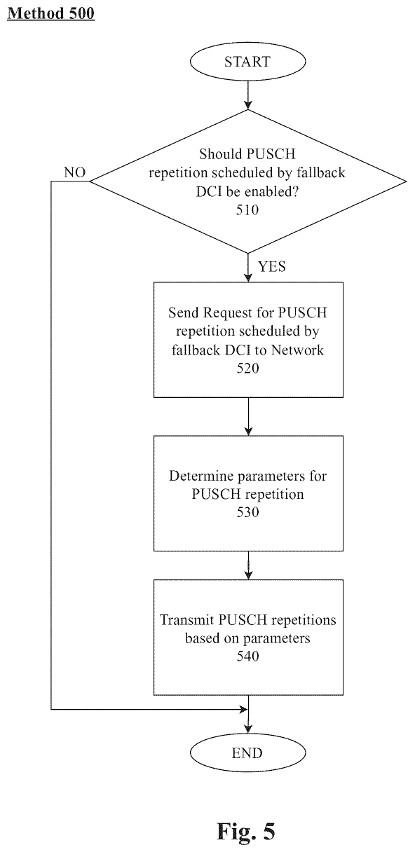

FIG. 5 shows an example method 500 for configuring and transmitting PUSCH repetitions scheduled by fallback DCI according to various example embodiments. The method 500 may be performed by the UE 110. In this example method, it is considered that the UE 110 has the capability of transmitting PUSCH repetitions.

In 510, the UE 110 determines whether the repetition should be enabled for PUSCH scheduled by fallback DCI. Some examples of parameters that may be used by the UE 110 to determine whether the PUSCH repetitions should be enabled were described above. These examples include a dedicated SSB RSRP threshold, using an SSB RSRP threshold associated with PRACH repetitions or using an SSB RSRP threshold associated with a Msg3 PUSCH. For example, if the UE 110 determines that the measured SSB RSRP is lower than the configured RSRP threshold, the UE 110 may determine that the PUSCH repetitions should be enabled.

If the UE 110 determines that the pusch repetitions are not to be enabled, the method 500 may end. On the other hand, if the UE 110 determines that the PUSCH repetitions should be enabled, in 520, the UE 110 sends a request to the network (e.g., the base station 300) requesting that the PUSCH repetitions be enabled. Some examples of transmitting the request to the network to enable PUSCH repetition were described above. These examples include using a PRACH resource or Msg3 PUSCH higher layer signaling.

In 530, the UE 110 determines the parameters related to transmitting the PUSCH repetitions. Some examples of the PUSCH repetition parameters and manners of signaling the parameters to the UE 110 were described above. These examples include repetition factors, frequency hopping and repetition version information. As also described above, some parameters for the PUSCH repetitions may vary based on whether the PUSCH repetitions are configured for PUSCH transmissions before or after RRC reconfiguration is complete.

In 540, the UE 110 will transmit the PUSCH repetitions to the base station 300 in accordance with the configured PUSCH parameters.

### EXAMPLES

In a first example, a method performed by a user equipment (UE), comprising decoding, based on signals received from a base station, first configuration information, determining, based on the first configuration information, that Physical Uplink Shared Channel (PUSCH) repetition is to be enabled for a PUSCH scheduled by fallback Downlink Control (DCI) and configuring transceiver circuitry to transmit, to the base station, a request to enable PUSCH repetition for the PUSCH scheduled by fallback DCI.

In a second example, the method of the first example, wherein the first configuration information is received in a System Information Block (SIB) transmitted by the base station and comprises a dedicated Synchronization Signal Block (SSB) Reference Signal Receive Power (RSRP) threshold for PUSCH repetition for PUSCH scheduled by fallback DCI, wherein the processing circuitry determines that PUSCH repetition for PUSCH scheduled by fallback DCI is to be enabled when a measured RSRP on SSBs transmitted by the base station is below the dedicated SSB RSRP threshold.

In a third example, the method of the first example, wherein the first configuration information comprises a Synchronization Signal Block (SSB) Reference Signal Receive Power (RSRP) threshold for Physical Random Access Channel (PRACH) repetition, wherein the processing circuitry determines that PUSCH repetition for PUSCH scheduled by fallback DCI is to be enabled when a measured RSRP on SSBs transmitted by the base station is below the SSB RSRP threshold.

In a fourth example, the method of the first example, wherein the first configuration information comprises a Synchronization Signal Block (SSB) Reference Signal Receive Power (RSRP) threshold for Msg3 repetition, wherein the processing circuitry determines that PUSCH repetition for PUSCH scheduled by fallback DCI is to be enabled when a measured RSRP on SSBs transmitted by the base station is below the SSB RSRP threshold.

In a fifth example, the method of the first example, wherein the first configuration information comprises a value for a Synchronization Signal Block (SSB) Reference Signal Receive Power (RSRP) threshold, wherein the processing circuitry determines that PUSCH repetition for PUSCH scheduled by fallback DCI is to be enabled for any measured RSRP on SSBs transmitted by the base station.

In a sixth example, the method of the first example, wherein the request to enable PUSCH repetition for PUSCH scheduled by fallback DCI is transmitted using a Physical Random Access Channel (PRACH) resource.

In a seventh example, the method of the sixth example, wherein the request comprises a first preamble associated with the request transmitted on a shared RACH occasion (RO) with a second preamble for a legacy UE.

In an eighth example, the method of the sixth example, wherein the request is transmitted on a RACH occasion (RO) that is different from a RO for a legacy UE.

In a ninth example, the method of the first example, wherein the request to enable PUSCH repetition for PUSCH scheduled by fallback DCI is transmitted using Msg3 PUSCH higher layer signaling.

In a tenth example, the method of the ninth example, wherein the Msg3 PUSCH higher layer signaling comprises (i) a logical channel identification (LCID) codepoint corresponding to enabling PUSCH repetition for PUSCH scheduled by fallback DCI, (ii) a Medium Access Control (MAC) sub-header corresponding to enabling PUSCH repetition for PUSCH scheduled by fallback DCI or (iii) an enhanced LCID (eLCID) corresponding to enabling PUSCH repetition for PUSCH scheduled by fallback DCI.

In an eleventh example, the method of the first example, further comprising decoding, based on signals received from the base station, a repetition factor for PUSCH repetition for PUSCH scheduled by fallback DCI.

In a twelfth example, the method of the eleventh example, further comprising decoding, based on signals received from the base station, second configuration information comprising candidate repetition factors, wherein the repetition factor is selected from the candidate repetition factors.

In a thirteenth example, the method of the eleventh example, wherein the repetition factor is selected from a set of default repetition factors.

In a fourteenth example, the method of the eleventh example, wherein the repetition factor is for PUSCH scheduled by fallback DCI that are to be transmitted after a radio resource control (RRC) reconfiguration is completed by the UE.

In a fifteenth example, the method of the fourteenth example, further comprising decoding, based on signals received from the base station, second configuration information comprising candidate repetition factors and Synchronization Signal Block (SSB) Reference Signal Receive Power (RSRP) thresholds corresponding to each of the candidate repetition factors, wherein the repetition factor is selected from the candidate repetition factors based on a measured RSRP on SSBs transmitted by the base station and the SSB RSRP thresholds.

In a sixteenth example, the method of the fourteenth example, further comprising decoding, based on signals received from the base station, uplink (UL) grant DCI comprising the repetition factor.

In a seventeenth example, the method of the sixteenth example, wherein the repetition factor is included in (i) a modulation and coding scheme (MCS) information field of the UL grant DCI, (ii) a time domain resource allocation (TDRA) information field of the UL grant DCI, or (iii) a Hybrid Automatic Repeat Request (HARQ) processing number information field of the UL grant DCI.

In an eighteenth example, the method of the fourteenth example, further comprising decoding, based on signals received from the base station, a PUSCH configuration information element (IE) comprising the repetition factor.

In a nineteenth example, the method of the eleventh example, wherein the repetition factor is for PUSCH scheduled by fallback UL DCI that are to be transmitted after Msg3 PUSCH and before a radio resource control (RRC) reconfiguration is completed by the UE.

In a twentieth example, the method of the nineteenth example, wherein the fallback UL DCI is DCI format 0_0.

In a twenty first example, the method of the first example, further comprising decoding, based on signals received from the base station, uplink (UL) grant DCI enabling frequency hopping for PUSCH repetitions for PUSCH scheduled by fallback DCI.

In a twenty second example, the method of the twenty first example, wherein an inter-slot frequency hopping resource block (RB) offset for PUSCH repetitions for PUSCH scheduled by fallback DCI is based on (i) an RB offset for Msg3 frequency hopping, (ii) an RB offset for Msg5 frequency hopping or (iii) an inter-slot frequency hopping pattern for PUSCH repetition type A.

In a twenty third example, the method of the first example, further comprising determining a repetition slot counting to be applied for PUSCH repetitions for PUSCH scheduled by fallback DCI.

In a twenty fourth example, the method of the twenty third example, wherein the repetition slot counting comprises consecutive slot-based counting where every slot is used for counting without respect to a type of the slot.

In a twenty fifth example, the method of the twenty third example, wherein the repetition slot counting comprises available slot-based counting where the available slots are determined based on a tdd-UL-DL-ConfigurationCommon information element (IE) or a ssb-PositionsInBurst IE provided to the UE.

In a twenty sixth example, the method of the twenty third example, wherein a type of the repetition slot counting is indicated to the UE using a system information block (SIB) transmitted by the base station.

In a twenty seventh example, the method of the first example, further comprising determining a repetition version for PUSCH repetitions for PUSCH scheduled by fallback DCI.

In a twenty eighth example, the method of the twenty seventh example, wherein the repetition version of a first repetition is based on a DCI with cyclic redundancy check (CRC) scrambled by a Cell Radio Network Temporary Identifier (C-RNTI).

In a twenty ninth example, the method of the twenty seventh example, wherein the repetition version is determined based on (i) a fixed repetition version or (ii) repetition version cycling according to transmission occasions.

In a thirtieth example, the method of the first example, further comprising configuring transceiver circuitry to transmit, to the base station, one or more PUSCH repetitions for PUSCH scheduled by fallback DCI based on second configuration information, wherein the second configuration information comprises (i) parameters for PUSCH repetition transmission when the one or more PUSCH repetitions are transmitted before the UE completes a radio resource control (RRC) reconfiguration or (ii) parameters for PUSCH repetition transmission when the one or more PUSCH repetitions are transmitted after the UE completes a RRC reconfiguration.

In a thirty first example, a processor configured to perform any of the methods of the first through thirtieth examples.

In a thirty second example, a user equipment comprising a transceiver configured to communicate with a base station and a processor communicatively coupled to the transceiver and configured to perform any of the methods of the first through thirtieth examples.

In a thirty third example, a method performed by a base station, comprising configuring transceiver circuitry to transmit first configuration information to a user equipment, wherein the first configuration information comprises an indication of when Physical Uplink Shared Channel (PUSCH) repetition is to be enabled for a PUSCH scheduled by fallback Downlink Control (DCI) and decoding, based on signals received from the UE, a request to enable PUSCH repetition for the PUSCH scheduled by fallback DCI.

In a thirty fourth example, the method of the thirty third example, wherein the first configuration information is transmitted in a System Information Block (SIB) and comprises a dedicated Synchronization Signal Block (SSB) Reference Signal Receive Power (RSRP) threshold for PUSCH repetition for PUSCH scheduled by fallback DCI, wherein PUSCH repetition for PUSCH scheduled by fallback DCI is to be enabled when a measured RSRP on SSBs transmitted by the base station is below the dedicated SSB RSRP threshold.

In a thirty fifth example, the method of the thirty third example, wherein the first configuration information comprises a Synchronization Signal Block (SSB) Reference Signal Receive Power (RSRP) threshold for Physical Random Access Channel (PRACH) repetition, wherein the PUSCH repetition for PUSCH scheduled by fallback DCI is to be enabled when a measured RSRP on SSBs transmitted by the base station is below the SSB RSRP threshold.

In a thirty sixth example, the method of the thirty third example, wherein the first configuration information comprises a Synchronization Signal Block (SSB) Reference Signal Receive Power (RSRP) threshold for Msg3 repetition, wherein the PUSCH repetition for PUSCH scheduled by fallback DCI is to be enabled when a measured RSRP on SSBs transmitted by the base station is below the SSB RSRP threshold.

In a thirty seventh example, the method of the thirty third example, wherein the first configuration information comprises a value for a Synchronization Signal Block (SSB) Reference Signal Receive Power (RSRP) threshold, wherein PUSCH repetition for PUSCH scheduled by fallback DCI is to be enabled for any measured RSRP on SSBs transmitted by the base station.

In a thirty eighth example, the method of the thirty third example, wherein the request to enable PUSCH repetition for PUSCH scheduled by fallback DCI is received on a Physical Random Access Channel (PRACH) resource.

In a thirty ninth example, the method of the thirty eighth example, wherein the request comprises a first preamble associated with the request transmitted on a shared RACH occasion (RO) with a second preamble for a legacy UE.

In a fortieth example, the method of the thirty eighth example, wherein the request is received on a RACH occasion (RO) that is different from a RO for a legacy UE.

In a forty first example, the method of the thirty third example, wherein the request to enable PUSCH repetition for PUSCH scheduled by fallback DCI is received using Msg3 PUSCH higher layer signaling.

In a forty second example, the method of the forty first example, wherein the Msg3 PUSCH higher layer signaling comprises (i) a logical channel identification (LCID) codepoint corresponding to enabling PUSCH repetition for PUSCH scheduled by fallback DCI, (ii) a Medium Access Control (MAC) sub-header corresponding to enabling PUSCH repetition for PUSCH scheduled by fallback DCI or (iii) an enhanced LCID (eLCID) corresponding to enabling PUSCH repetition for PUSCH scheduled by fallback DCI.

In a forty third example, the method of the thirty third example, further comprising configuring transceiver circuitry to transmit a repetition factor for PUSCH repetition for PUSCH scheduled by fallback DCI.

In a forty fourth example, the method of the forty third example, further comprising configuring transceiver circuitry to transmit second configuration information comprising candidate repetition factors, wherein the repetition factor is selected from the candidate repetition factors.

In a forty fifth example, the method of the forty third example, wherein the repetition factor is selected from a set of default repetition factors.

In a forty sixth example, the method of the forty third example, wherein the repetition factor is for PUSCH scheduled by fallback DCI that are to be transmitted after a radio resource control (RRC) reconfiguration is completed by the UE.

In a forty seventh example, the method of the forty sixth example, further comprising configuring transceiver circuitry to transmit second configuration information comprising candidate repetition factors and Synchronization Signal Block (SSB) Reference Signal Receive Power (RSRP) thresholds corresponding to each of the candidate repetition factors, wherein the repetition factor is selected from the candidate repetition factors based on a measured RSRP on SSBs transmitted by the base station and the SSB RSRP thresholds.

In a forty eighth example, the method of the forty sixth example, further comprising configuring transceiver circuitry to transmit uplink (UL) grant DCI comprising the repetition factor.

In a forty ninth example, the method of the forty eighth example, wherein the repetition factor is included in (i) a modulation and coding scheme (MCS) information field of the UL grant DCI, (ii) a time domain resource allocation (TDRA) information field of the UL grant DCI, or (iii) a Hybrid Automatic Repeat Request (HARQ) processing number information field of the UL grant DCI.

In a fiftieth example, the method of the forty sixth example, further comprising configuring transceiver circuitry to transmit a PUSCH configuration information element (IE) comprising the repetition factor.

In a fifty first example, the method of the forty third example, wherein the repetition factor is for PUSCH scheduled by fallback UL DCI that are to be transmitted after Msg3 PUSCH and before a radio resource control (RRC) reconfiguration is completed by the UE.

In a fifty second example, the method of the fifty first example, wherein the fallback UL DCI is DCI format 0_0.

In a fifty third example, the method of the thirty third example, further comprising configuring transceiver circuitry to transmit uplink (UL) grant DCI enabling frequency hopping for PUSCH repetitions for PUSCH scheduled by fallback DCI.

In a fifty fourth example, the method of the fifty third example, wherein an inter-slot frequency hopping resource block (RB) offset for PUSCH repetitions for PUSCH scheduled by fallback DCI is based on (i) an RB offset for Msg3 frequency hopping, (ii) an RB offset for Msg5 frequency hopping or (iii) an inter-slot frequency hopping pattern for PUSCH repetition type A.

In a fifty fifth example, the method of the thirty third example, wherein the first configuration information comprises a repetition slot counting to be applied for PUSCH repetitions for PUSCH scheduled by fallback DCI.

In a fifty sixth example, the method of the fifty fifth example, wherein the repetition slot counting comprises consecutive slot-based counting where every slot is used for counting without respect to a type of the slot.

In a fifty seventh example, the method of the fifty fifth example, wherein the repetition slot counting comprises available slot-based counting where the available slots are determined based on a tdd-UL-DL-ConfigurationCommon information element (IE) or a ssb-PositionsInBurst IE provided to the UE.

In a fifty eighth example, the method of the fifty fifth example, further comprising configuring transceiver circuitry to transmit a system information block (SIB) comprising a type of the repetition slot counting.

In a fifty ninth example, the method of the fifty third example, further comprising configuring transceiver circuitry to transmit a DCI with cyclic redundancy check (CRC) scrambled by a Cell Radio Network Temporary Identifier (C-RNTI) comprising a repetition version for PUSCH repetitions for PUSCH scheduled by fallback DCI.

In a sixtieth example, the method of the fifty ninth example, wherein the repetition version is determined based on (i) a fixed repetition version or (ii) repetition version cycling according to transmission occasions.

In a sixty first example, the method of the thirty third example, further comprising decoding, based on signals received from the UE, one or more PUSCH repetitions for PUSCH scheduled by fallback DCI based on second configuration information, wherein the second configuration information comprises (i) parameters for PUSCH repetition transmission when the one or more PUSCH repetitions are transmitted before the UE completes a radio resource control (RRC) reconfiguration or (ii) parameters for PUSCH repetition transmission when the one or more PUSCH repetitions are transmitted after the UE completes a RRC reconfiguration.

In a sixty second example, a processor configured to perform any of the methods of the thirty third through sixty first examples.

In a sixty third example, a base station comprising a transceiver configured to communicate with a user equipment and a processor communicatively coupled to the transceiver and configured to perform any of the methods of the thirty third through sixty first examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signals received from a base station, first configuration information;
determine, based on the first configuration information, that Physical Uplink Shared Channel (PUSCH) repetition is to be enabled for a PUSCH scheduled by fallback Downlink Control (DCI); and
configure transceiver circuitry to transmit, to the base station, a request to enable PUSCH repetition for the PUSCH scheduled by fallback DCI.

2. The apparatus of claim 1, wherein the first configuration information is received in a System Information Block (SIB) transmitted by the base station and comprises a dedicated Synchronization Signal Block (SSB) Reference Signal Receive Power (RSRP) threshold for PUSCH repetition for PUSCH scheduled by fallback DCI, wherein the processing circuitry determines that PUSCH repetition for PUSCH scheduled by fallback DCI is to be enabled when a measured RSRP on SSBs transmitted by the base station is below the dedicated SSB RSRP threshold.

3. The apparatus of claim 1, wherein the first configuration information comprises a Synchronization Signal Block (SSB) Reference Signal Receive Power (RSRP) threshold for Physical Random Access Channel (PRACH) repetition, wherein the processing circuitry determines that PUSCH repetition for PUSCH scheduled by fallback DCI is to be enabled when a measured RSRP on SSBs transmitted by the base station is below the SSB RSRP threshold.

4. The apparatus of claim 1, wherein the first configuration information comprises a Synchronization Signal Block (SSB) Reference Signal Receive Power (RSRP) threshold for Msg3 repetition, wherein the processing circuitry determines that PUSCH repetition for PUSCH scheduled by fallback DCI is to be enabled when a measured RSRP on SSBs transmitted by the base station is below the SSB RSRP threshold.

5. The apparatus of claim 1, wherein the first configuration information comprises a value for a Synchronization Signal Block (SSB) Reference Signal Receive Power (RSRP) threshold, wherein the processing circuitry determines that PUSCH repetition for PUSCH scheduled by fallback DCI is to be enabled for any measured RSRP on SSBs transmitted by the base station.

6. The apparatus of claim 1, wherein the request to enable PUSCH repetition for PUSCH scheduled by fallback DCI is transmitted using a Physical Random Access Channel (PRACH) resource.

7. The apparatus of claim 6, wherein the request comprises a first preamble associated with the request transmitted on a shared RACH occasion (RO) with a second preamble for a legacy UE.

8. The apparatus of claim 6, wherein the request is transmitted on a RACH occasion (RO) that is different from a RO for a legacy UE.

9. The apparatus of claim 1, wherein the request to enable PUSCH repetition for PUSCH scheduled by fallback DCI is transmitted using Msg3 PUSCH higher layer signaling.

10. The apparatus of claim 9, wherein the Msg3 PUSCH higher layer signaling comprises (i) a logical channel identification (LCID) codepoint corresponding to enabling PUSCH repetition for PUSCH scheduled by fallback DCI, (ii) a Medium Access Control (MAC) sub-header corresponding to enabling PUSCH repetition for PUSCH scheduled by fallback DCI or (iii) an enhanced LCID (eLCID) corresponding to enabling PUSCH repetition for PUSCH scheduled by fallback DCI.

11. The apparatus of claim 1, wherein the processing circuitry is further configured to:
decode, based on signals received from the base station, a repetition factor for PUSCH repetition for PUSCH scheduled by fallback DCI.

12. The apparatus of claim 11, wherein the processing circuitry is further configured to:
decode, based on signals received from the base station, second configuration information comprising candidate repetition factors, wherein the repetition factor is selected from the candidate repetition factors.

13. The apparatus of claim 11, wherein the repetition factor is selected from a set of default repetition factors.

14. The apparatus of claim 11, wherein the repetition factor is for PUSCH scheduled by fallback DCI that are to be transmitted after a radio resource control (RRC) reconfiguration is completed by the UE.

15. The apparatus of claim 14, wherein the processing circuitry is further configured to:
decode, based on signals received from the base station, second configuration information comprising candidate repetition factors and Synchronization Signal Block (SSB) Reference Signal Receive Power (RSRP) thresholds corresponding to each of the candidate repetition factors, wherein the repetition factor is selected from the candidate repetition factors based on a measured RSRP on SSBs transmitted by the base station and the SSB RSRP thresholds.

16. The apparatus of claim 14, wherein the processing circuitry is further configured to:
decode, based on signals received from the base station, uplink (UL) grant DCI comprising the repetition factor.

17. The apparatus of claim 16, wherein the repetition factor is included in (i) a modulation and coding scheme (MCS) information field of the UL grant DCI, (ii) a time domain resource allocation (TDRA) information field of the UL grant DCI, or (iii) a Hybrid Automatic Repeat Request (HARQ) processing number information field of the UL grant DCI.

18. The apparatus of claim 14, wherein the processing circuitry is further configured to:
decode, based on signals received from the base station, a PUSCH configuration information element (IE) comprising the repetition factor.

19. The apparatus of claim 11, wherein the repetition factor is for PUSCH scheduled by fallback UL DCI that are to be transmitted after Msg3 PUSCH and before a radio resource control (RRC) reconfiguration is completed by the UE.

20. The apparatus of claim 19, wherein the fallback UL DCI is DCI format 0_0.
